(19) United States
(12) Patent Application Publication
(10) Pub. No.: US 2016/0292203 A1
(43) Pub. Date: Oct. 6, 2016

(54) PROCESS CONTROL METHOD FOR DATABASE, MEDIUM, AND DATABASE SERVER

(71) Applicant: FUJITSU LIMITED, Kawasaki-shi (JP)

(72) Inventors: Yoshihiro TSUJIKAWA, Kobe (JP); Hisaya FUJII, Numazu (JP); Naoki NAKATOGAWA, Kawasaki (JP); Yasuhiro SUZUKI, Yokohama (JP)

(73) Assignee: FUJITSU LIMITED, Kawasaki-shi (JP)

(21) Appl. No.: 15/068,983

(22) Filed: Mar. 14, 2016

(30) Foreign Application Priority Data
Mar. 31, 2015 (JP) 2015-074599

(51) Int. Cl. G06F 17/30

(52) U.S. Cl. CPC G06F 17/30353

(57) ABSTRACT

A process control method for a database includes storing identification information of an updating processing in a first storage region in association with update data when executing the updating processing for updating data stored in the first storage region of the database to the update data, and storing the identification information and a confirmation time in association with each other in a second storage region that is different from the first storage region in response to a confirmation processing of the updating processing.

### CROSS-REFERENCE TO RELATED APPLICATION

This application is based upon and claims the benefit of priority of the prior Japanese Patent Application No. 2015-074599, filed on Mar. 31, 2015, the entire contents of which are incorporated herein by reference.

### FIELD

The embodiments discussed herein are related to a process control method for a database, a medium, and a database server.

### BACKGROUND

A portion of the records included in a database are subjected to referencing, updating, inserting, and erasing processes according to external instructions. Furthermore, records that are processed at a specific time may be specified and batch processing may be conducted on the specified records. At this time, a record is provided with an update flag, the update flag is set when the data in the record is updated, and the update flag is checked when a specific time period has elapsed, whereby the data updated during the specific time period is detected and treated as subject data to be subjected to processing such as batch processing. After the batch processing is completed, the update flag is erased again. A similar technique is described in Japanese Laid-open Patent Publication No. 2012-173826.

### SUMMARY

According to an aspect of the invention, a process control method for a database includes causing identification information allocated to an updating processing to be stored in a first storage region in association with update data when carrying out the updating processing for updating data stored in the first storage region of the database to the update data; and causing the identification information and a confirmation time to be stored in association with each other in a second storage region that is different from the first storage region in response to a confirmation processing of the updating processing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a configuration of a database server;

FIG. 2A illustrates an example of a real data table;

FIG. 2B illustrates an example of a real data table after the real data table illustrated in FIG. 2A is processed;

FIG. 3 illustrates an example of a commit time management table;

FIG. 4 illustrates an example of a hardware configuration of a database server;

FIG. 5 illustrates an example of a connection state between a database server and an application server;

FIG. 6 is a flow chart depicting procedures for processing data using transactions according to a first embodiment;

FIG. 7 is a flow chart depicting procedures for processing data based on a commit time according to the first embodiment;

FIG. 8A illustrates an example of the real data table before commit time reflection processing;

FIG. 8B illustrates an example of the real data table after commit time reflection processing;

FIG. 9 is a flow chart depicting procedures for reflection processing for the real data table of a commit time according to a second embodiment;

FIG. 10 is a flow chart depicting procedures for processing data using transactions according to the second embodiment; and

FIG. 11 is a flow chart depicting procedures for processing data based on a commit time according to the second embodiment.

### DESCRIPTION OF EMBODIMENTS

According to conventional technology, when using an update flag, the processing for setting and releasing the flags for each record is forced thus making the database processing complicated. Moreover, when a plurality of batches are processed for which specific time periods do not match, the processing objects among the batches to be processed are not specified with one type of update flag.

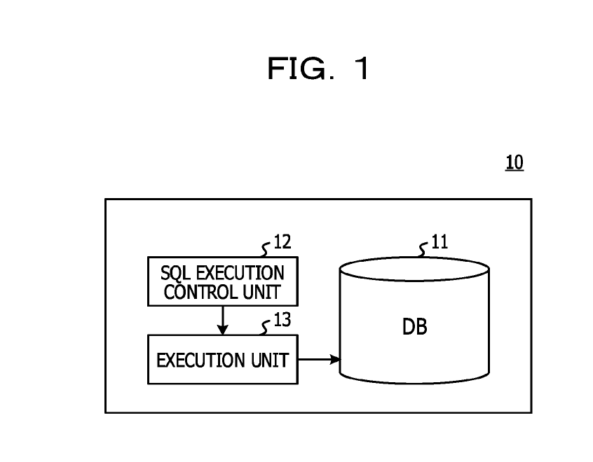

The embodiments of the present invention will be explained in detail with reference to the figures below. FIG. 1 illustrates an example of a configuration of a database server 10 according to an embodiment. The database server 10 has a database 11, a structure query language (SQL) execution control unit 12, and an execution unit 13. The database server 10 is not limited to the above configuration and, for example, the database 11 may be stored in a storage device in an external device connected to the database server 10.

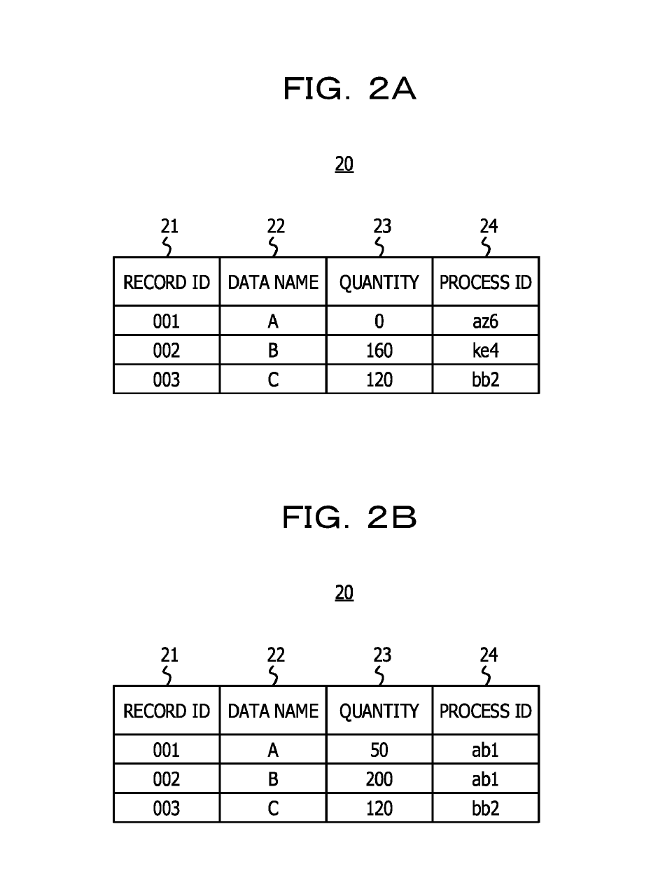

The database 11 is a collection of data (information) systematically recorded in a storage device such as a hard disk drive (HDD). The embodiments discuss an example of a relational database (RDB) for managing data in a tabular form. The database 11 includes, for example, a real data table 20 and a commit time management table 30. FIG. 2A illustrates an example of the real data table 20. Records in the real data table 20 include, for example, a record ID 21, a data name 22, a quantity 23, and a process ID 24. The record ID 21 is information for identifying the record. The data name 22 is data for indicating a name such as a product name and the like. The quantity 23 is data for indicating the quantity of the product. The process ID 24 is information for identifying the processing to be performed on the record. The record may include other data in place of the product name and the quantity.

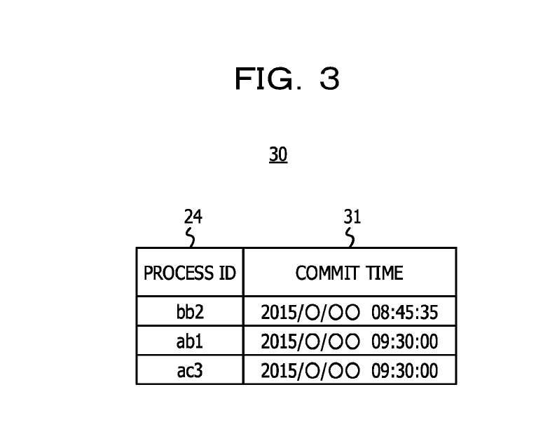

FIG. 3 illustrates an example of the commit time management table 30 which is stored in a storage region different from that of the real data table in FIG. 2A. The records of the commit time management table 30 include items such as the process ID 24 and a commit time 31. The commit time management table 30 is a table in which the process ID 24 and the commit time 31 information are stored in association with each other. The process ID 24 in the real data table in FIG. 2A and the process ID 24 in the commit time management table 30 correspond to the same process so long as the ID is the same. The commit time 31 is the time, for example, when the execution unit 13 accepts an instruction to commit from the SQL execution control unit 12.

As illustrated in FIG. 1, the SQL execution control unit 12 receives an operation instruction for operating the database 11 using SQL and controls processing based on the contents of the received instruction. For example, the SQL execution control unit 12 issues an instruction pertaining to the execution of processing to the execution unit 13 based on the contents of a received instruction. The operation instruction for operating the database 11 using SQL may indicate the transmission of data by an application server connected through a communication network with the database server 10 based on an operation inputted by a user.

The execution unit 13 executes processing on the data in the database 11 in response to an instruction from the SQL execution control unit 12. For example, referencing, updating, inserting, and erasing are included in the processing.

When, for example, data processing is performed due to a transaction and the processing is committed (confirmed), the execution unit 13 causes the database 11 to store the information of the commit time 31 in association with the data subjected to the processing and commits the processing of the data.

FIG. 2B illustrates an example of the real data table after the real data table illustrated in FIG. 2A is processed. For example, as illustrated in FIG. 2A and FIG. 2B (see record ID 21 “001” and record ID 21 “002”), when performing the processing of data in the real data table 20, the process ID 24 is updated to a new process ID 24 based on the process ID 24 assigned to the processing. Specifically, the process ID 24 is updated from the stored “az6” to the process ID 24 “ab1” assigned to the executed processing in the record of the record ID 21 “001” because processing for updating the quantity from “0” to “50” is executed. The execution unit 13 then obtains the information of the commit time 31 and stores the information in the commit time management table 30 by associating the process ID 24 and the commit time 31 information, and then commits the data processing.

When executing the data processing specified in accordance with the commit time, the execution unit 13 refers to the commit time management table 30, specifies the record of the processing object in the real data table 20, and executes the processing.

Specifically, the execution unit 13 refers to the commit time management table 30 in response to an instruction including a time period condition from the SQL execution control unit 12 and extracts the process ID 24 associated with the commit time 31 that satisfies the time period condition. The time period condition is, for example, a prescribed range for commit times. Next, the execution unit 13 specifies the record of the processing object in the real data table 20 based on the extracted process ID 24 and executes the processing on the specified record. In this case, the execution unit 13 may obtain the information of the commit time 31 and store the information in the commit time management table 30 by associating the information of the process ID 24 and the commit time 31, and then may commit the processing.

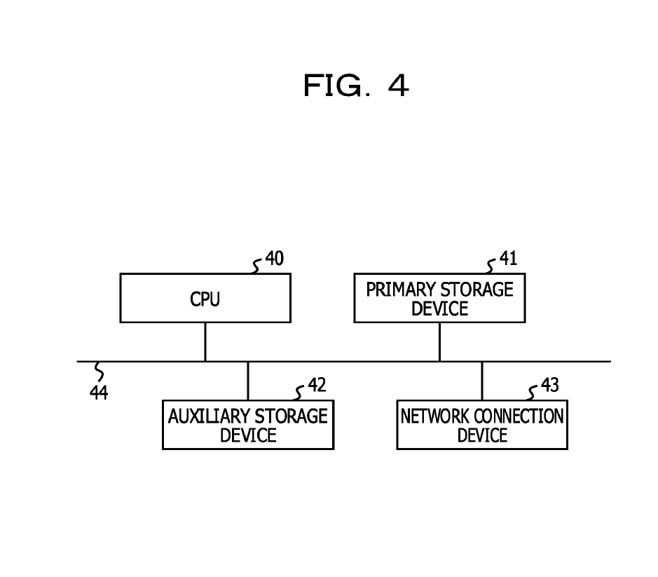

FIG. 4 illustrates an example of a hardware configuration of the database server 10 according to the embodiments of the present disclosure. The database server 10 has a central processing unit (CPU) 40, a primary storage device 41, an auxiliary storage device 42, and a network connection device 43, and the devices and units are all connected to each other through a system bus 44.

The CPU 40 controls processing of the database server such as various computations and data input/output with other hardware units based on an operating system (OS) and various programs stored in the primary storage device 41 for example, and executes various types of processing. The CPU 40 functions as the SQL execution control unit 12 and the execution unit 13 and the like based on control programs according to the embodiments.

The primary storage device 41 temporarily stores at least a portion of the OS and the various programs executed by the CPU 40. The primary storage device 41 stores various types of data used in processing by the CPU 40. The primary storage device 41 is a memory such as a read-only memory (ROM) or a random access memory (RAM) for example.

The auxiliary storage device 42 stores for example control programs according to the embodiments and control programs provided in the database server. The auxiliary storage device 42 is able to read and write various types of stored information based on control signals from the CPU 40. The auxiliary storage device is a storage such as a hard disk drive (HDD) or a solid state drive (SSD). The auxiliary storage device 42 stores the database 11 and information used in the processing of the embodiments. The primary storage device 41 and the auxiliary storage device 42 may mutually carry out the functions of the other device.

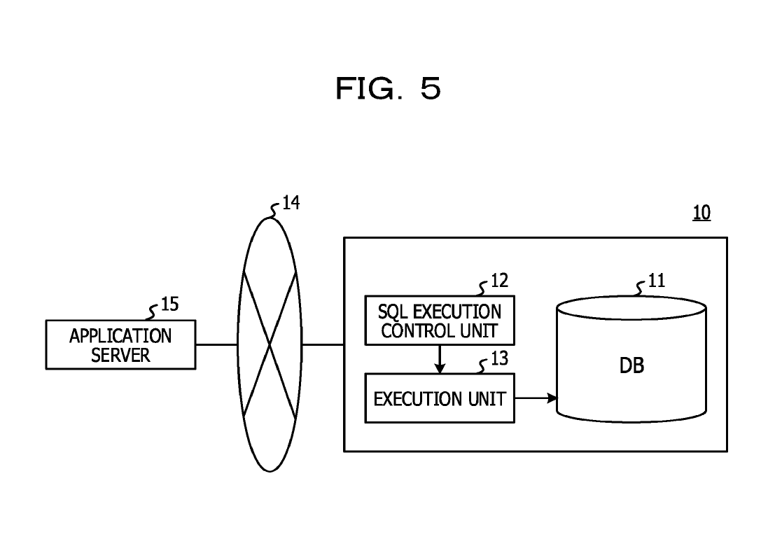

The network connection device 43 carries out communication with an application server 15 connected via a communication network 14 as illustrated in FIG. 5 based on control signals from the CPU 40 for example. FIG. 5 illustrates an example of a connection state between a database server and an application server. While the database server 10 and the application server 15 are exemplified as separate devices, the configuration is not limited as such and one server may carry out both functions of the database server and the application server.

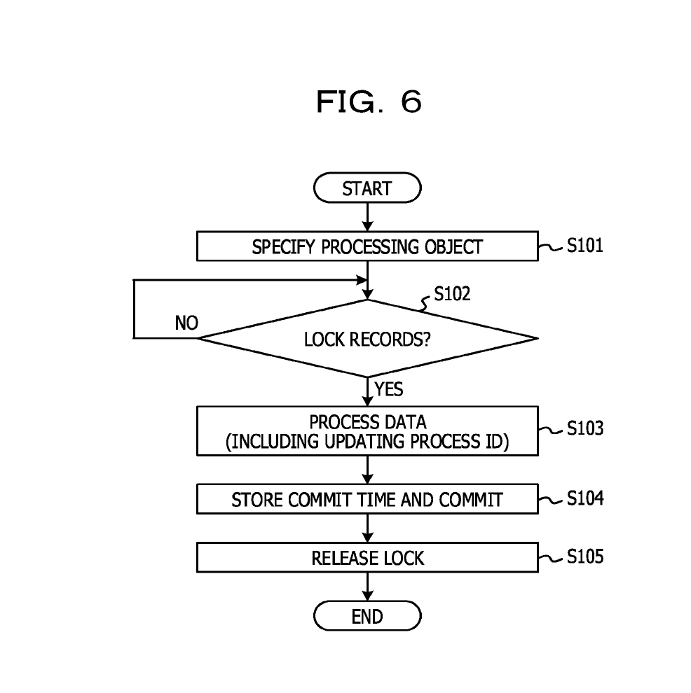

Next, procedures for data processing using transactions for example in the database server 10 according to the first embodiment will be explained. Referencing, updating, inserting, and erasing are included in the processing. FIG. 6 is a flow chart depicting procedures for processing data.

For example, the execution unit 13 searches in the real data table 20 and specifies a record of a processing object in the real data table 20 in response to an instruction including the contents of the data processing, the information of the processing object, and the process ID 24 from the SQL execution control unit 12 that received the instruction for data processing from the application server 15 (S101). The information of the processing object is for example the record ID 21. The execution unit 13 prohibits (locks) other processes from accessing the records for all the specified records (S102).

If the record is locked (S102 Yes), the execution unit 13 executes the processing according to the instruction from the SQL execution control unit 12 on the locked records (S103). The processing includes, for example, updating the process ID 24. When the processing is determined to have been carried out normally, the execution unit 13 obtains the commit time 31 and stores the commit time 31 in the commit time management table 30 in association with the updated process ID 24 and commits the processing (S104). After the committing, the execution unit 13 releases the lock on all the processed records (S105). If the records are not locked (S102 No), the processing waits temporarily. The execution unit 13 executes the same processing when the records are locked or are released from exclusivity such as other processing.

If the processing of the data fails for any reason, the execution unit 13 determines that the processing was not carried out normally, does not commit the processing, executes rollback processing, and returns the records to the state before processing.

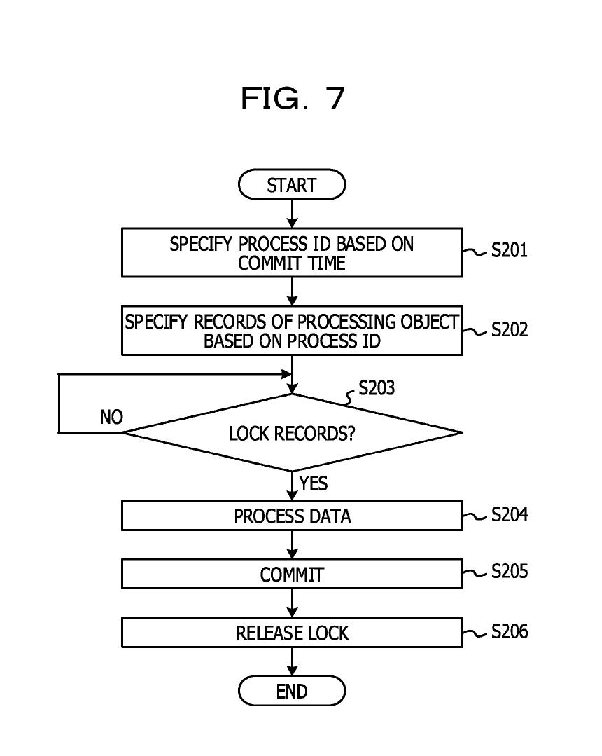

Next, procedures for data processing based on the commit time in the database server 10 according to the first embodiment will be explained. Referencing, updating, inserting, and erasing are included in the processing. FIG. 7 is a flow chart depicting procedures for data update processing based on a commit time.

For example, the execution unit 13 searches through the commit time management table 30 and obtains the process ID 24 associated with the commit time 31 that satisfies the designated time period condition in response to an instruction including the contents of the data processing and the information of the processing object from the SQL execution control unit 12 that receives an instruction for data processing from the application server 15 (S201). The information of the processing object is for example the time period condition. Next, the execution unit 13 searches through the real data table 20 and specifies records associated with the obtained process ID 24 (S202). The execution unit 13 prohibits (locks) other processes from accessing all the specified records (S203).

If the records are locked (S203 Yes), the execution unit 13 executes the processing according to the instruction from the SQL execution control unit 12 on the locked records (S204). Next, the execution unit 13 commits the processing when it is determined that the processing is carried out normally (S205). After carrying out the committing, the execution unit 13 releases the lock on all the processed records (S206).

If the records are not locked (S203 No), the processing waits temporarily. The execution unit 13 executes the same processing when the records are locked or are released from exclusivity such as other processing.

If the processing of the data fails for any reason, the execution unit 13 determines that the processing was not carried out normally, does not commit the processing, executes rollback processing, and returns the records to the state before the update processing.

According to the first embodiment, the database 11 stores processed data and the commit time 31 in association with each other. The storage of the process ID 24 and the commit time 31 may involve updating only one record in the commit time management table 30 for one instance of processing so that the amount of processing is reduced and the processing time is shortened. As a result, the database server 10 is able to limit processing costs and leakages and is able to execute processing on the desired data by using the commit time 31 and by specifying, as the data of the processing object, the data of the processing object when carrying out batch processing for specifying data included in the prescribed time zone of the commit time 31.

The lock for the exclusive control by the execution unit 13 may be a shared lock or an exclusive lock. More specifically, the execution unit 13 may establish a shared lock which allows referencing by other transactions but does not allow updating, or may establish an exclusive lock which does not permit referencing or updating from other transactions. Moreover, the scope of the data to be locked may include the entire table or may be in units of records.

A second embodiment of the present disclosure will be explained in detail with reference to the figures. The execution unit 13 in the database server 10 according to the second embodiment executes processing to reflect the commit time 31 stored in the commit time management table 30 in the real data table 20 in addition to the various types of processing according to the first embodiment.

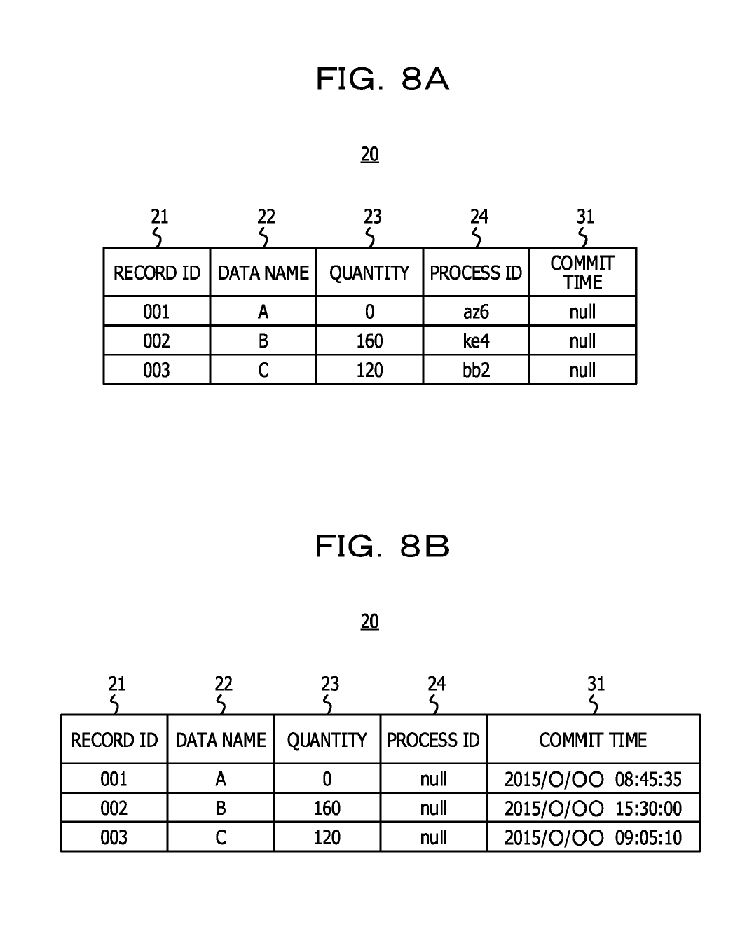

The execution unit 13 executes processing to reflect the commit time 31 stored in the commit time management table 30 in the real data table 20 based on, for example, a previously set schedule. FIG. 8A illustrates an example of a real data table before the commit time reflection processing. As illustrated in FIG. 8A, records in the real data table 20 include, for example, the record ID 21, the data name 22, the quantity 23, the process ID 24, and the commit time 31.

The execution unit 13 refers to the commit time management table 30 and extracts a pair of the process ID 24 and the commit time 31. The execution unit 13 refers to the real data table 20 and searches for and specifies the corresponding records based on the extracted process ID 24. The execution unit 13 then stores the extracted commit time 31 in the specified records. As illustrated in FIG. 8B, when the commit time 31 is stored in the real data table 20, the execution unit 13 may erase the process ID 24 of the record. Erasing refers to causing the records to enter a null state for example. FIG. 8B illustrates an example of a real data table after the commit time reflection processing.

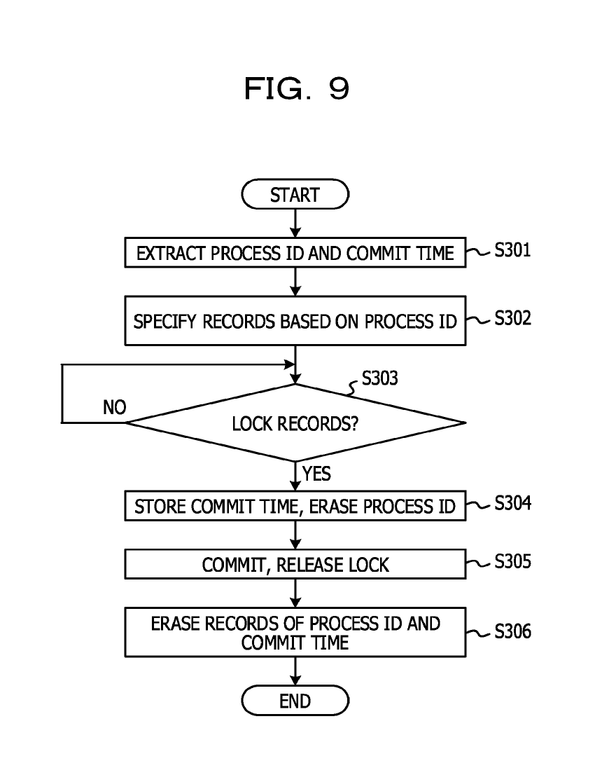

Procedures for reflecting the commit time 31 stored in the commit time management table 30 in the real data table 20 of the database server 10 according to the second embodiment will be explained. FIG. 9 is a flow chart depicting procedures for reflection processing for a real data table of a commit time.

First, the execution unit 13 refers to the commit time management table 30 and extracts the pair of the process ID 24 and the commit time 31 in the uppermost row of the table for example (S301). The execution unit 13 searches through the real data table 20 and specifies records to be updated based on the extracted process ID 24 (S302). The execution unit 13 locks other processes from accessing the specified records (S303).

If the records are locked (S303 Yes), the execution unit 13 stores the extracted commit time 31 and erases the stored process ID 24 (creates a null state) (S304). The execution unit 13 commits the processing and releases the lock on the records (S305). After the reflection processing in the real data table 20, the execution unit 13 erases the records of the process ID 24 and the commit time 31 from the commit time management table 30 (S306).

If the records are not locked (S303 No), the processing waits temporarily. The execution unit 13 executes the same processing when the records are locked or are released from exclusivity such as other processing.

In the above procedures, although the execution unit 13 reflects the commit time 31 in the real data table 20 and then erases the records of the process ID 24 and the commit time 31 from the commit time management table 30, the configuration is not limited as such. For example, in addition to extracting the process ID 24 and the commit time 31 from the commit time management table 30 (S301), the execution unit 13 may erase the extracted process ID 24 and the commit time 31 from the commit time management table 30 and then reflect the extracted process ID 24 and the commit time 31 in the real data table 20.

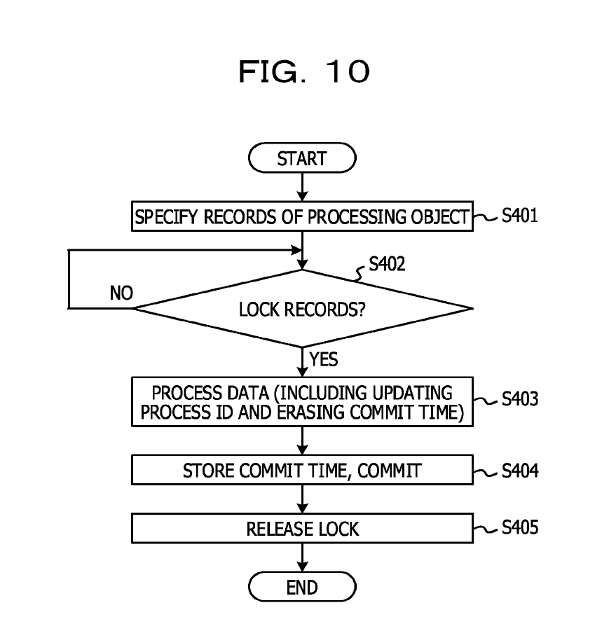

Next, procedures for data processing using transactions for example in the database server 10 according to the second embodiment will be explained. Referencing, updating, inserting, and erasing are included in the processing. FIG. 10 is a flow chart depicting procedures for processing data.

For example, the execution unit 13 searches through the real data table 20 and specifies a record of a processing object in the real data table 20 in response to an instruction including the contents of the data processing, the information of the processing object, and the process ID 24 from the SQL execution control unit 12 that received the instruction for data processing from the application server 15 (S401). The information of the processing object is, for example, the record ID 21. The execution unit 13 prohibits (locks) other processes from accessing all the specified records (S402).

If the record is locked (S402 Yes), the execution unit 13 executes the processing according to the instruction from the SQL execution control unit 12 on the locked records (S403). The processing involves updating the process ID 24 and erasing the commit time 31 (creating a null state) for example. When the processing is determined to have been carried out normally, the execution unit 13 obtains the commit time 31 and stores the commit time 31 in the commit time management table 30 and associates the commit time 31 with the updated process ID 24 and commits the processing (S404). After carrying out the committing, the execution unit 13 releases the lock on all the processed records (S405).

If the records are not locked (S402 No), the processing waits temporarily. The execution unit 13 executes the same processing when the records are locked or are released from exclusivity such as other processing.

If the processing of the data fails for any reason, the execution unit 13 determines that the processing was not carried out normally, does not commit the processing, executes rollback processing, and returns the records to the state before processing.

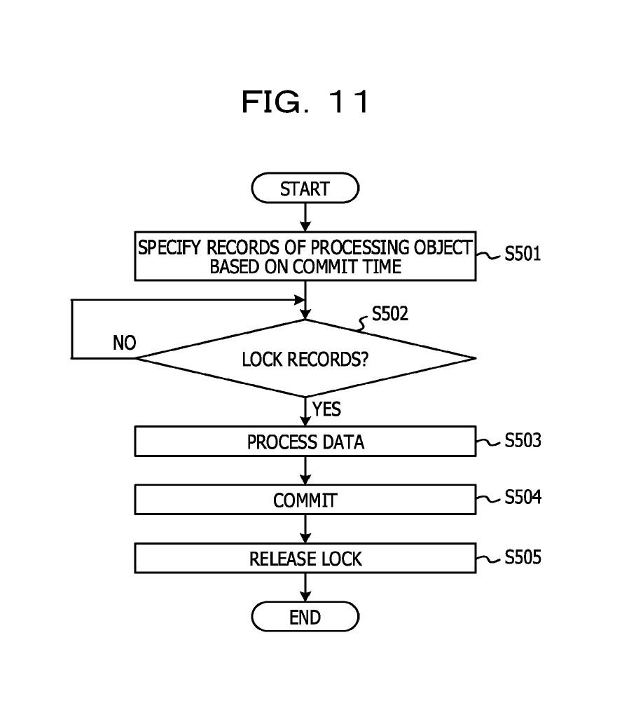

Next, procedures for data processing based on the commit time in the database server 10 according to the second embodiment will be explained. Referencing, updating, inserting, and erasing are included in the processing. FIG. 11 is a flow chart depicting procedures for processing data based on a commit time.

For example, the execution unit 13 searches through the real data table 20 and specifies the record associated with the commit time 31 that satisfies the designated time period condition in response to an instruction including the contents of the data processing and the information of the processing object (e.g., a time period condition and the like) from the SQL execution control unit 12 that receives an instruction for data processing from the application server 15 (S501). The commit time 31 is obtained from the commit time management table 30 based on the process ID 24 for the record in which the commit time 31 is “null” and the record of the processing object is specified. The execution unit 13 prohibits (locks) other processes from accessing all the specified records (S502).

If the record is locked (S502 Yes), the execution unit 13 executes the processing according to the instruction from the SQL execution control unit 12 on the locked records (S503). Next, the execution unit 13 commits the processing when it is determined that the processing is carried out normally (S504). After carrying out the committing, the execution unit 13 releases the lock on all the processed records (S505).

If the records are not locked (S502 No), the processing waits temporarily. The execution unit 13 executes the same processing when the records are locked or are released from exclusivity such as other processing.

If the processing of the data fails for any reason, the execution unit 13 determines that the processing was not carried out normally, does not commit the processing, executes rollback processing, and returns the records to the state before processing.

According to the second embodiment, because the commit time 31 is reflected in the real data table 20, that is, because the record for which the reflected commit time 31 is stored can be erased (released) from the commit time management table 30, overloading of the commit time management table 30 can be suppressed. The amount of searching in the commit time management table 30 by the execution unit 13 during processing can also be suppressed. Moreover, during the processing of the data based on the commit time 31, the execution unit 13 is able to carry out the processing without referring to the commit time management table 30 because the commit time 31 is stored in the real data table 20. The execution unit 13 may search through both the real data table 20 and the commit time management table 30 and specify the data associated with the commit time that satisfies the subject time period condition for considering data that is not reflected in the real data table 20.

While an format that the process ID 24 and the commit time 31 are stored in separate fields has been explained, the real data table 20 is not limited in the format. For example, the process ID 24 and the commit time 31 may be stored in one field. That is, either process ID 24 or the commit time 31 may be stored as appropriate.

The database may be applied to a column-oriented database in the second embodiment. The storage and access of data is carried out in column units in a column-oriented database. As a result, the column-oriented database is superior in batch updating of a small number of columns with regard to a large number of rows and the processing for reflecting the commit time 31 in the real data table 20 can be performed at high speed.

The present disclosure is not limited to the configurations and procedures of the above embodiments and the processing methods may be changed or recombined as appropriate without departing from the scope of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A process control method for a database, the method comprising:
storing identification information of an updating processing in a first storage region in association with update data when executing the updating processing for updating data stored in the first storage region of the database to the update data; and
storing the identification information and a confirmation time in association with each other in a second storage region that is different from the first storage region in accordance with a confirmation processing of the updating processing.

2. The process control method for a database according to claim 1, the method further comprising:
further causing the confirmation time to be stored in the first storage region in association with the update data corresponding to the identification information after confirmation processing with regard to update data corresponding to the identification information has been carried out; and
enabling the storage region of the identification information and the confirmation time stored in the second storage region to be used in a storage region of another identification information and another confirmation time.

3. A processing method for a database, the method comprising:
when detecting identification information stored in association with a confirmation time within a predetermined time band in a first storage region, setting update data stored in a second storage region in association with the detected identification information as data of a processing object for a first process of which an object is a data stored in association with the confirmation time within the predetermined time band ,the identification information stored in association with the update data in the second storage region in accordance with a second process, the second process updating a data in the second storage region to the update data, the confirmation time stored in association with the identification information in the first storage region different from the first storage region in accordance with the second process.

4. A process control method for a database, the method comprising:
specifying data by searching in the database based on a confirmation time, the data being stored in association with the confirmation time of processing when processing of data stored in a database is carried out, and
setting the specified data as a processing object.

5. A computer-readable recording medium having stored therein a process control program for a database, the program that causes a computer to execute a process comprising:
store identification information allocated to an updating processing in a first storage region in association with update data when carrying out the updating processing for updating data stored in the first storage region of the database to the update data; and
store the identification information and a confirmation time in association with each other in a second storage region that is different from the first storage region in response to a confirmation processing of the updating processing.

6. A database server comprising:
a processor that executes a process, the process comprising:
storing identification information of an updating processing in a first storage region in association with update data when executing the updating processing for updating data stored in the first storage region of the database to the update data; and
storing the identification information and a confirmation time in association with each other in a second storage region that is different from the first storage region in response to a confirmation processing of the updating processing.

7. A database server comprising:
a processor that executes a process, the process comprising:
when detecting identification information stored in association with a confirmation time within a predetermined time band in a first storage region, setting update data stored in a second storage region in association with the detected identification information as data of a processing object for a process that a object of the process is a data stored in association with the confirmation time within the predetermined time band , the identification information stored in association with the update data in the second storage region in accordance with a second process, the second process updating a data in the second storage region to the update data, the confirmation time stored in association with the identification information in the first storage region different from the second storage region in accordance with the second process.
